(19) United States
(12) Patent Application Publication
(10) Pub. No.: US 2023/0299709 A1
(43) Pub. Date: Sep. 21, 2023

(54) PHOTOVOLTAIC SYSTEM HAVING A CABLE SUPPORT STRUCTURE

(71) Applicant: VECON GmbH, Heusweiler (DE)

(72) Inventor: Johann CZALOUN, Meran (IT)

(73) Assignee: VECON GmbH, Heusweiler (DE)

(21) Appl. No.: 18/018,639

(22) PCT Filed: Aug. 3, 2021
(86) PCT No.: PCT/EP2021/071631

§ 371 Date: Jan. 30, 2023

(30) Foreign Application Priority Data
Aug. 4, 2020 (IT) 102020000019123

(51) Int. Cl. H02S 20/30

(52) U.S. Cl. CPC H02S 20/30

(57) ABSTRACT

A photovoltaic system having a cable or cable bundle, includes at least one photovoltaic module. The photovoltaic module is suspended from the cable or cable bundle, wherein the center of gravity of the photovoltaic module is below the cable or cable bundle, and wherein the photovoltaic module swings relative to at least one pivot axis which is substantially parallel to the longitudinal extent of the cable or cable bundle, and the photovoltaic module has a rigidity which is sufficient to substantially maintain its shape even under load.

The present invention relates to a photovoltaic system having a cable support structure according to the preamble of patent claim 1.

A large number of cable mechanisms for holding photovoltaic modules or support structures of the mentioned photovoltaic modules, the so-called panels for photovoltaic modules, are known from the prior art. The purpose of these mechanisms is to hold the photovoltaic modules so as to utilize the sunlight in the best way to generate energy. Such mechanisms are often very complicated and therefore require a lot of maintenance and are complex to produce. In the mechanisms of the prior art, safety precautions and dimensions are required so as to avoid breakages under wind and/or snow loads.

The cable structures known hitherto for holding photovoltaic modules generally provide a plurality of cables which are suspended at a certain height between posts and fix a row of modules in a previously defined orientation, wherein the orientation is in some cases adjustable by means of mechanisms which are generally based on moving the cables connected to the modules.

In many cases, a plurality of modules are fixed to a rigid frame, and the frame is then held by the cables.

The three-dimensional orientation is complicated, however, wherein a plurality of cables and a plurality of fixing points are necessary.

The defined orientation is susceptible to the weather, such as in wind and snow, because the orientation should be as horizontal as possible in order to avoid high wind loads, while it should be as vertical as possible in order to reduce the snow load.

It is therefore not possible to fulfil both requirements with systems that are not pivotable.

On the other hand, systems with the possibility of adjusting the orientation are able to fulfil the requirement only partially because of their limited rotatability, wherein they are moreover complicated and temperamental.

A system with a rigid orientation of the modules is moreover sensitive to cyclic vibrations caused by wind loads, which cyclic vibrations are attributable to resonance and can cause a great deal of damage.

EP 2 476 140 discloses a photovoltaic system which is formed by a plurality of photovoltaic modules on at least two mutually parallel support cables stretched between two anchor points, wherein the photovoltaic modules are supported by trusses or by holders arranged entirely above the cables, wherein these trusses or holders consist of at least one frame that is rigid in the transverse direction and one frame that is rigid in the longitudinal direction, and are anchored to the support cables by means of clamps.

In that publication there are provided a plurality of cables which are spaced apart from one another and rigidly support and orient the modules, and the modules are therefore at risk of breaking under wind load.

EP 3 683 960 discloses a photovoltaic system having photovoltaic modules which are arranged substantially vertically, in particular double-sided photovoltaic modules, that is to say energy of the sunlight is obtained on both sides of the photovoltaic module. In this way, both the front side and the rear side of the photovoltaic module can be irradiated by the sun. The photovoltaic modules can be arranged substantially in the north-south direction, whereby sunlight from both the east and the west can be captured.

DE 10 2008 059 858 discloses a ground-mounted photovoltaic system in which a cable-like tension element is arranged between at least two holding devices. The solar panel is arranged on the cable-like tension element by way of a fixing element on the rear side of the solar panel. A panel of this type is able to absorb sunlight on only one side owing to its orientation and the considerable shading on the rear side.

In order to hold the panel at the intended angle, the frame must reach deep below the cable and be heavy in that region. As a result of the relatively central position of the cable relative to the module surface and the large frame mass that is necessary, the system can readily be excited to vibrate in wind and is additionally exposed to high wind and snow loads as a result of the large projected area.

In a further embodiment, the panel is held in position by an additional cable, as a result of which they are again exposed to considerable snow and wind loads. The support structure must therefore be so configured that it is able to absorb the wind forces.

None of these systems solves the problem which can occur at the solar panels as a result of wind forces and the like, and there is therefore the risk that the systems will be damaged by these forces, wherein in particular obliquely or vertically arranged modules, as are expedient in particular in the case of bifacial modules, provide a large contact surface for the wind and are thus exposed to high stresses and could therefore break.

These problems occur in particular in the case of photovoltaic systems with large dimensions, in particular with a number of at least four photovoltaic modules, because, where there is a limited number of modules and therefore a limited extent of these modules, the modules can be monitored and can be secured and/or dismantled in the case of adverse weather forecasts.

Systems that are produced with at least four photovoltaic modules cannot be dismantled or secured within a short time.

In the present invention, cables are understood as being ropes, cables, wires, in particular metal wires, straps, tubes, chains and the like, and a cable bundle is understood as being one or more cables which are substantially parallel to one another and close together.

In the present invention, “substantially” is understood as meaning a range of −+5° or +−5%.

Photovoltaic modules are understood as being modules and/or panels or other surfaces which convert sunlight into electrical energy, as well as multiple elements combined to form a single module and/or flexible photovoltaic strips which are arranged in frames or fixed to panels or the like.

The object of the present invention is to produce a photovoltaic system according to the characterizing part of patent claim 1.

There is proposed a photovoltaic system having a cable or cable bundle comprising at least one photovoltaic module.

According to the invention, the photovoltaic module is suspended from the cable or cable bundle, wherein the photovoltaic module is arranged completely, that is to say in its entirety, below the cable or cable bundle, and the photovoltaic module is arranged so as to swing freely relative to at least one longitudinal axis lying substantially to the longitudinal extent of the cable or cable bundle. The pivot axis is substantially parallel to the longitudinal extent of the cable or cable bundle and runs through the cable/cable bundle itself or through connectors attached to the cable/cable bundle or around the contact points of the cable field.

By means of this arrangement, the modules are able to rotate largely into the horizontal in strong wind, and thus minimize the wind loads.

The longitudinal extent of the cable or cable bundle can be the local extent in the connecting region photovoltaic module cable or cable bundle or between the holding points of the cable or cable bundle, also called the span.

The photovoltaic module has a rigidity which is sufficient to substantially maintain its shape even under load. That is to say, it maintains its shape in the wind and, unlike a sail or a flag, does not deform under the whirling forces of the wind.

The photovoltaic system according to the invention comprises a support structure by means of which a cable or cable bundle is held and/or stretched. At least one photovoltaic module, preferably a row of photovoltaic modules, which swing freely relative to a pivot axis, is suspended from or connected to the cable or cable bundle. This connection can also be referred to as an oscillating connection because the photovoltaic module oscillates when it is exposed to wind forces.

In a preferred embodiment, the photovoltaic module is suspended substantially perpendicularly and so that it is arranged completely below the cable, that is to say in a vertical direction. These photovoltaic modules are connected to the cable by means of a connector, for example. In a first embodiment, the connection between the cable and the connector and the photovoltaic module is a fixed connector, that is to say, when the photovoltaic module is exposed to a force, for example a wind force, which begins to pivot or swing the photovoltaic module and the photovoltaic module pivots also in that the cable is twisted or the entire span pivots.

In a second embodiment, the connection between the photovoltaic module and the cable is a connection which permits mutual rotation. In this case, when the photovoltaic module is exposed to a force, for example a wind force, the photovoltaic module swings freely relative to the cable or cable bundle.

The photovoltaic modules are suspended perpendicularly, that is to say substantially vertically, when the modules are not exposed to external forces such as, for example, the wind. This is also advantageous for the efficiency of the power generation if the photovoltaic module is a double-sided (bifacial) module. This means that both sides of the photovoltaic module convert sunlight into electrical energy. A particularly advantageous embodiment is present when the modules are oriented along the north-south axis. In this case, peak values of the energy production are present in the mornings and evenings. Although the photovoltaic module or the photovoltaic modules swing or pivot under the force of the wind, both sides of the photovoltaic module are able to generate energy by virtue of the diffuse light which is radiated off the surrounding land, for example.

Advantageously, this system can be used, for example, in agriculture or the like, where plants are placed in the ground and the system according to the invention is suspended at a certain height from the ground. This also has the advantage of forming shade or partial shade for the plants.

For systems arranged above cultivated areas, the holding structures of the cables, which are called posts or pillars, must be spaced apart considerably in order to ensure free access to the area located therebelow, wherein a long span, a large distance between the holding structures, is required. Shading by solar panels must additionally be as uniform as possible over the cultivated areas. As a result, it is necessary to attach the modules as evenly as possible to the long spans, which is possible only with a large number of modules per cable.

In one embodiment, the system according to the invention comprises at least four photovoltaic modules which are arranged in a row along a cable or cable bundle. In this way, economically expedient coverage of an area, such as a farm for commercial purposes, is ensured.

This embodiment provides a system which withstands the forces of wind and snow loads easily and reliably.

Further features and details of the invention will become apparent from the patent claims and from the description of a preferred, non-limiting embodiment, which is shown in the accompanying drawings, in which:

FIG. 1 is a perspective view of a photovoltaic system having a cable and a module according to a first embodiment according to the invention,

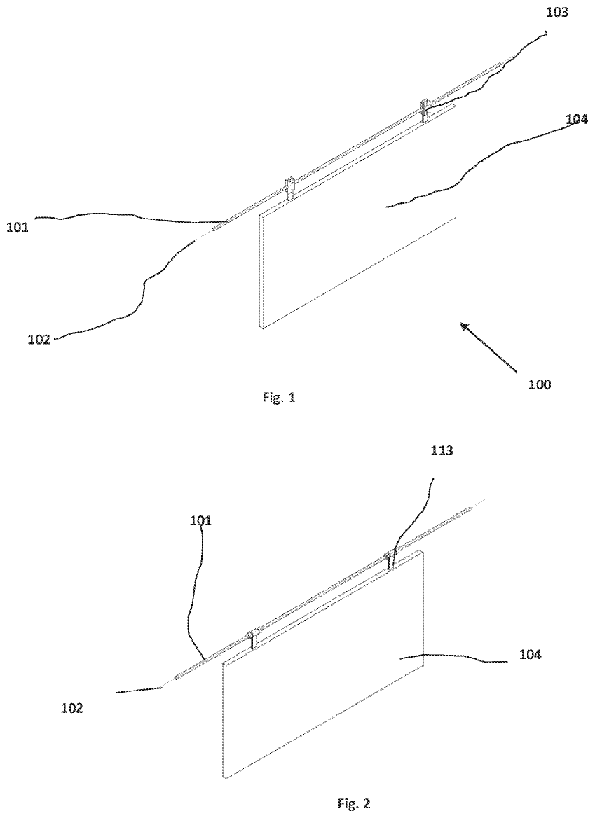

FIG. 2 is a perspective view of a photovoltaic system having a cable and a module according to a second embodiment according to the invention,

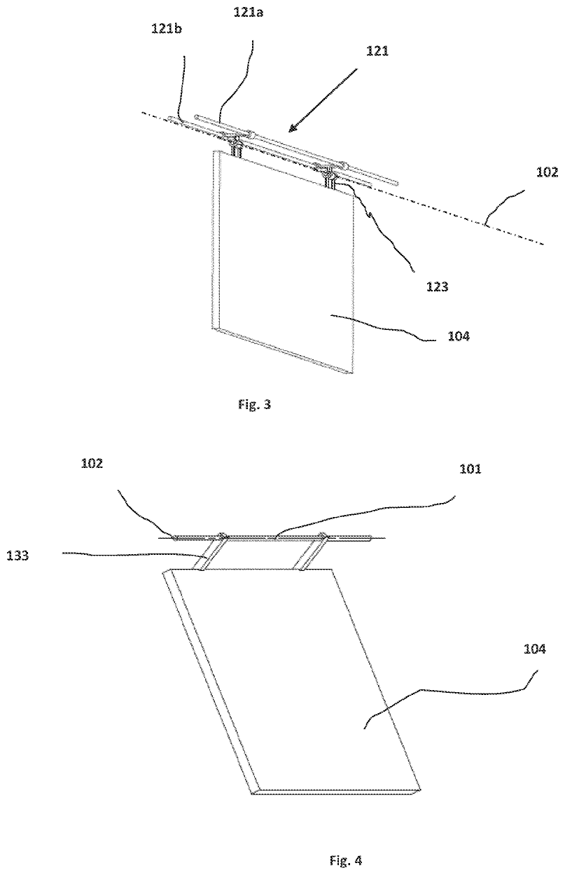

FIG. 3 is a perspective view of a photovoltaic system having a cable and a module according to a further embodiment according to the invention,

FIG. 4 is a perspective view of a photovoltaic system having a cable and a module according to a further embodiment according to the invention,

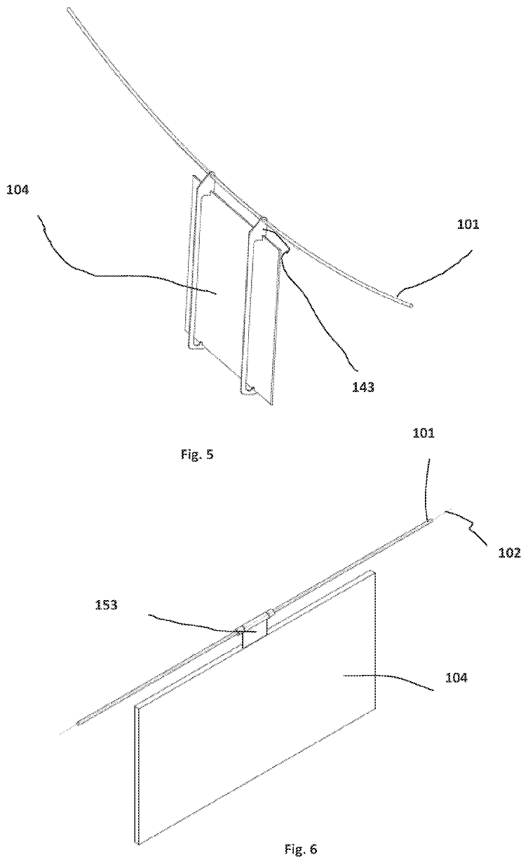

FIG. 5 is a perspective view of a photovoltaic system having a cable and a module according to a further embodiment according to the invention,

FIG. 6 is a perspective view of a photovoltaic system having a cable and a module according to a further embodiment according to the invention,

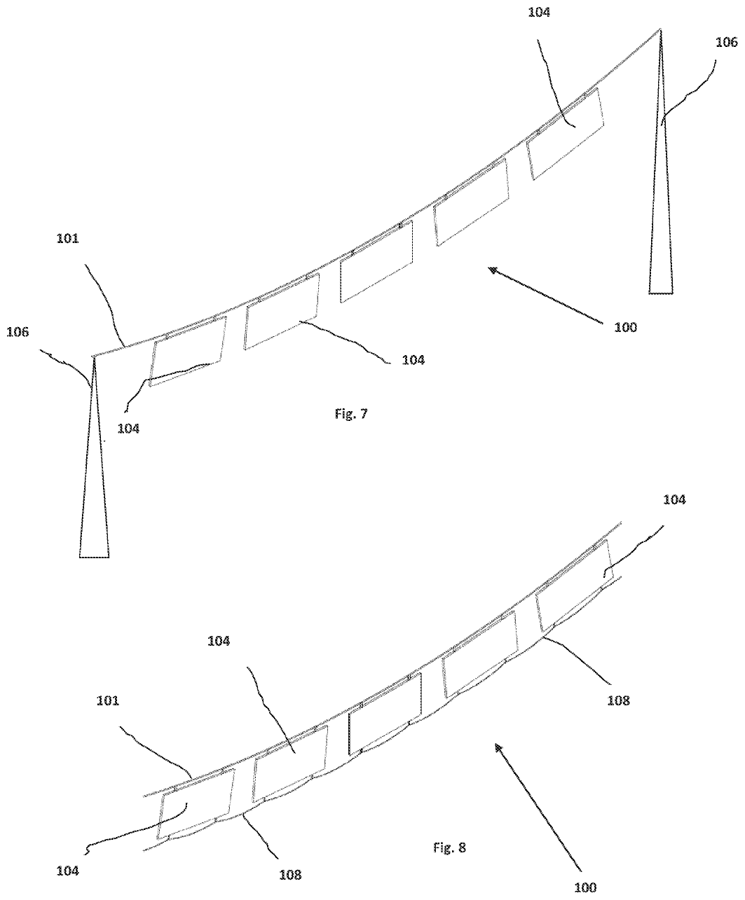

FIG. 7 is a perspective view of a photovoltaic system having a cable and a row of photovoltaic modules according to an embodiment according to the invention, and

FIG. 8 is a perspective view of a photovoltaic system having a cable and a row of photovoltaic modules according to an embodiment according to the invention, having a damping element.

FIG. 1 shows a photovoltaic system 100 according to the invention, which comprises a cable 101. Connected to the cable 101 are two connectors 103, which connect the photovoltaic module 104 to the cable 101. The photovoltaic module 104 is suspended so as to swing freely relative to a pivot axis 102. The pivot axis 102 is substantially parallel to the longitudinal extent of the cable 101.

The longitudinal extent of the cable 101 can be that of a local connecting region photovoltaic module 104—cable 101 or between the holding points, also called the span.

In this first embodiment, the connector is clamped to the cable 101 and is therefore a rotationally fixed connection between the photovoltaic module 104 and the cable 101. If the photovoltaic module 104 is exposed to a wind force, it swings and is exposed to the wind. The cable or cable bundle also pivots with the photovoltaic module 104 and is twisted. In this way, there is no risk of breakage of the photovoltaic module 104.

FIG. 2 shows a second embodiment of the invention, in which the cable 101 is connected to the photovoltaic module 104 by a connection 113 which permits pivoting between the photovoltaic module 104 and the cable 101. In this particular embodiment, the connector 113 is formed by two connectors 113 which are formed by tubular elements within which the cable 101 extends, and these tubular elements are connected to the photovoltaic module 104. By way of this connection, pivoting of the photovoltaic module 104 relative to the cable 101 is made possible. The pivot axis 102 about which the photovoltaic module 104 pivots passes through the tubular elements within which the cable 101 is arranged.

In a further embodiment shown in FIG. 3, a cable bundle 121 is formed by two cables 121a and 121b. The cable bundle is formed by a number of cables 121a, 121b, which run close to one another, preferably two cables 121a, 121b. This cable bundle 121 can have the advantage that if one cable breaks, the other cable still holds the photovoltaic module 104. This can be particularly advantageous for safety reasons in the case of use in areas in which people are present.

The connection 123 between the cables and the photovoltaic module 104 can be produced in a such a manner that the photovoltaic module 104 is spaced apart equally from the individual cables 121a, 121b.

The photovoltaic module 104 swings under external forces relative to the pivot axis 102 in the connection 123, wherein, for example, a hinge for swinging is present.

FIG. 4 shows a further embodiment of the photovoltaic system according to the invention, in which the connector between the cable 101 and the photovoltaic module 104 inclines the photovoltaic module 104 relative to the vertical axis. In this embodiment, the photovoltaic module 104 is still able to swing about the pivot axis 102.

FIG. 5 shows a further embodiment, in which the connector 143 forms a structure which encloses the photovoltaic module 104, wherein pivoting relative to the pivot axis 102 is likewise permitted, however.

FIG. 6 shows a further embodiment, in which the photovoltaic module 104 is connected to the cable 101 by way of a single connector. This connector 153 has a longitudinal extent in this embodiment. The photovoltaic module is still able to pivot about the axis 102 and swing substantially freely.

FIG. 7 shows a photovoltaic system 100 according to the invention, in which there are two holders 106 in symbolic form, which explain that the cable 101 is stretched between the two holders of the holding structure 106 at a distance from the ground.

As mentioned above, photovoltaic modules 104 are advantageously suspended in a freely swinging manner below the cable 101, and plants can be placed in the ground below the cable 101 or the space can be used in another way.

FIG. 8 shows a further embodiment of a system 100 according to the invention, in which there are elements 108 which connect the individual photovoltaic modules 102 in order to ensure damping of the swing, in particular of the swing between two photovoltaic modules 104. This element 108 can be a cable, for example, or also an elastic element.

The elements 108 are used to avoid torsional stresses in the cable 101 between two connectors of two different photovoltaic modules.

In a preferred embodiment, the frame of the photovoltaic module is in such a form that it does not cast shadows onto the photovoltaic cells which are arranged on both sides, or in the case of bifacial cells when the sunlight is incident at an angle of +−60°.

In a preferred embodiment, the cable/cable bundle 101 is not arranged between the direct sunlight/solar radiation and the photovoltaic module 104. By means of this arrangement, shading on both sides of the photovoltaic module is avoided. The projection area of the photovoltaic module 104 is not overlain by the cable/cable bundle 101, so that shading is avoided. Shading of even only one cell can have a major impact, because the efficiency of all the cells, which are connected in series, is thereby reduced.

The variants described above serve only the purpose of better understanding of the structure, the mode of operation and the properties of the proposed solution, but they do not limit the disclosure in respect of the exemplary embodiments. The figures are schematic, wherein properties and important effects are in some cases clearly shown on an enlarged scale in order to emphasize the functions, principles of action, configurations and technical features. Any mode of operation, any principle, any technical configuration and any feature that is disclosed in the figures or in the text may be combined freely and arbitrarily with all the patent claims, wherein any feature in the text and in the other figures, other modes of operation, principles, configurations and technical features that are contained in this disclosure or follow therefrom and also all conceivable combinations are to be attributed to the described solution. Combinations between all the individual statements in the text, that is to say in any paragraph of the text, in the patent claims and also combinations between the different variants in the text, in the dimensions and in the figures are included. The details of the device and of the method are shown associated with one another; it is noted, however, that they may also be combined independently of one another and also freely with one another. The ratios shown in the figures of the individual parts and offsets thereof with one another and their dimensions and proportions are not to be interpreted as being limiting. Individual dimensions and proportions may also differ from those shown. The patent claims also do not limit the disclosure and therefore the possible combinations of all the presented features. All the presented features are here also disclosed individually and in combination with all other features.

### LIST OF REFERENCE NUMERALS

100 Photovoltaic system having a cable or cable bundle
101 Cable
102 Pivot axis
103 Connector/connections
104 Photovoltaic module
106 Holding structure
108 Cable/damping element
113 Connector/connection
121 Cable bundle
121a, 121b Cables of the cable bundle
123 Connector/connection
133 Connector/connection
143 Connector/connection
153 Connector/connection

1. A photovoltaic system (100) having a cable (101) or cable bundle (121), comprising at least one photovoltaic module (104), wherein the photovoltaic module (104) is suspended from the cable (101) or cable bundle (121), wherein the photovoltaic module (104) is located in its entirety below the cable (101) or cable bundle (121) from which it is suspended, and wherein the photovoltaic module (104) swings relative to at least one pivot axis (102) which is substantially parallel to the longitudinal extent of the cable (101) or cable bundle (121) and is formed by the cable/cable bundle (101) itself or by connectors (103, 113, 123, 133, 143, 153) attached to the cable/cable bundle, and the photovoltaic module (104) has a rigidity which is sufficient to substantially maintain its shape even under load, and wherein at least two opposite sides of the photovoltaic module are able to convert sunlight into electrical energy, and wherein the photovoltaic module (104) has a frame.

2. The photovoltaic system (100) according to claim 1, wherein the photovoltaic module (104) is connected to the cable (101) or cable bundle (121) by means of at least of two connectors (103, 113, 123, 133, 143).

3. The photovoltaic system (100) according to claim 1, wherein the photovoltaic module (104) is connected to the cable (101) or cable bundle (121) by means of a single connector (153).

4. The photovoltaic system (100) according to claim 1, wherein the photovoltaic module is formed of bifacial cells.

5. The photovoltaic system (100) according to claim 1, wherein the cable (101) or cable bundle (121) is connected to the photovoltaic module (104) in a rotationally fixed manner by means of the connectors (103, 113, 123, 133, 143, 153).

6. The photovoltaic system (100) according to claim 1, wherein the photovoltaic module (104) is connected so as to be pivotable relative to the cable (101) or cable bundle (121) about the pivot axis (102).

7. The photovoltaic system (100) according to claim 1, wherein the photovoltaic module (4) is connected to a single cable (101).

8. The photovoltaic system (100) according to claim 1, wherein the photovoltaic module is connected to a cable bundle (121), and wherein the cable bundle comprises at least two cables (121a, 121b).

9. The photovoltaic system (100) according to claim 1, wherein the photovoltaic module (104) is suspended substantially perpendicularly below the cable (101) or cable bundle (121) when it is not exposed to external forces.

10. The photovoltaic system (100) according to claim 1, wherein the system comprises at least four photovoltaic modules (104) which are arranged in a row along a cable (101) or cable bundle (121).

11. The photovoltaic system (100) according to claim 1, wherein the photovoltaic modules (104) are connected together by way of an element (108) for damping the swing, in particular a cable.

12. The photovoltaic system (100) according to claim 1, wherein, when the angle of incidence of the sunlight on the photovoltaic module is +−60°, the frame does not cast any shadows onto the photovoltaic module.

13. The photovoltaic system (100) according to claim 1, wherein the cable/cable bundle (101) from which the photovoltaic module (104) is suspended is not arranged between the direct sunlight and the photovoltaic module (104).
